(19) United States
(12) Patent Application Publication
(10) Pub. No.: US 2009/0242322 A1
(43) Pub. Date: Oct. 1, 2009

(54) DAMPER AND FIXING DEVICE USING THE SAME

(75) Inventor: Ho-Yuan Tsai, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PEGATRON CORPORATION, Taipei City (TW)

(21) Appl. No.: 12/407,550

(22) Filed: Mar. 19, 2009

(30) Foreign Application Priority Data
Mar. 26, 2008 (TW) 097110677

(51) Int. Cl. F16F 7/00

(52) U.S. Cl. 181/207

(57) ABSTRACT

The invention discloses a damper including a damping portion, a first pillar-shaped portion, a second pillar-shaped portion and a first block portion. The damping portion has a first end and a second end. The first pillar-shaped portion protrudes from the first end of the damping portion, and the second pillar-shaped portion protrudes from the second end of the damping portion. The first pillar-shaped portion has a third end away from the first end of the damping portion, and the first block portion protrudes from the third end. In the invention, the damper can fix a speaker to a base directly without screws.

### BACKGROUND OF THE INVENTION

1. Field of the Invention

The invention relates to a damper and, more particularly, to a damper which can fix a speaker without screws to achieve a damping function.

2. Description of the Prior Art

A notebook computer is widely used nowadays. With the continual progress and development of science and technology, besides the calculating and processing ability, the notebook computer also can provide other various functions by other peripheral devices or built-in electronic components. Since modern people pay more attention to the audio and video effect, a speaker is an essential and important device in the notebook computer.

Generally speaking, the speaker is built in the notebook computer to facilitate the carry. However, the notebook computer becomes more and more light, slim, short and small. Therefore, when the speaker works in a limited space, if there is no effective damping measure, the resonance of the speaker and the case occurs, and this makes some noise.

FIG. 1 is a sectional diagram showing the fixing device 1 fixing the speaker 3 in a prior art. As shown in FIG. 1, the fixing device 1 includes a damper 10, a base 12 and a screw 14. The damper 10 is usually made of elastic material such as rubber. When the components are assembled, first, the speaker 3 is fastened to an indentation portion 100 of the damper 10. Then, a hole of the damper 10 is disposed correspondingly to a screwed hole of a fixing base 120 on a base 12. Afterward, the screw 14 goes through the hole of the damper 10, and then the screw thread at the front end of the screw 14 is screwed to the screwed hole of the fixing base 120.

The above mode of fixing the speaker 3 has the following disadvantages. First, since only the portion coordinating with the screwed hole of the fixing base 120 has screw thread, the screw 14 needs to be custom-made. Second, two to four screws 14 are needed to fix the speaker 3, and this will increase the manufacturing cost. Third, tools are needed to fix or detach the damper 10, which is inconvenient.

To solve the problems above, the invention provides a new damper for fixing the speaker without screws.

### SUMMARY OF THE INVENTION

The invention provides a new damper which can fix a speaker to a base in a fastening mode without screws.

According to an embodiment, the damper in the invention is used to assemble a speaker to a base. The damper includes a damping portion, a first pillar-shaped portion, a second pillar-shaped portion and a first block portion. The damping portion has a first end and a second end. The first pillar-shaped portion protrudes from the first end of the damping portion, and the second pillar-shaped portion protrudes from the second end of the damping portion. The second pillar-shaped portion is fastened to the base. The first pillar-shaped portion has a third end away from the first end of the damping portion, and the first block portion protrudes from the third end. The speaker is fastened to the first pillar-shaped portion and between the damping portion and the first block portion.

When the components are assembled, first, the first fastening portion of the speaker is fastened to the first pillar-shaped portion of the damper. After fastened, the first fastening portion of the speaker is located between the damping portion of the damper and the first block portion. Then, the second fastening portion on the base is fastened to the second pillar-shaped portion of the damper. In the embodiment, the second pillar-shaped portion is hollow. This allows the second fastening portion of the base to enter into the second pillar-shaped portion to be fastened inside the second pillar-shaped portion.

In addition, the second pillar-shaped portion of the damper also has a fourth end away from the second end of the damping portion. In another embodiment, the damper in the invention may additionally includes a third block portion protruding from the fourth end of the second pillar-shaped portion to allow the second fastening portion of the base to be fastened to the third block portion directly.

Therefore, according to the damper in the invention, the special structure design allows a user to fix the speaker to the base in a fastening mode using the damper directly. In the invention, the screws are not needed, and the resonance of the speaker and the casing is prevented. Thus, the material cost of screws is saved, and the components can be assembled easily without tools.

These and other features, aspects and advantages of the present invention will become better understood with regard to the following description, appended claims, and accompanying drawings.

### BRIEF DESCRIPTION OF THE APPENDED DRAWINGS

FIG. 1 is a sectional diagram showing a fixing device fixing a speaker in a prior art;

FIG. 2A is a schematic diagram showing the appearance of the fixing device fixing the object according to an embodiment of the invention;

FIG. 2B is an exploded diagram showing the fixing device and the object shown in FIG. 2A;

FIG. 2C is a front view showing the damper in FIG. 2B;

FIG. 2D is a sectional diagram taken along section line X-X in FIG. 2A;

FIG. 3A is a schematic diagram showing the appearance of the damper according to another embodiment of the invention;

FIG. 3B is a front view showing the damper in FIG. 3A;

FIG. 3C is a sectional diagram showing that the damper in FIG. 3A fixes the object to the base;

FIG. 4A is a schematic diagram showing the appearance of the fixing device fixing the object according to still another embodiment of the invention;

FIG. 4B is an exploded diagram showing the fixing device and the object shown in FIG. 4A;

FIG. 4C is a front view showing the damper in FIG. 4B;

FIG. 4D is a sectional diagram taken along section line Y-Y in FIG. 4A;

FIG. 5A is a schematic diagram showing the appearance of the damper according to a fourth embodiment of the invention; and

FIG. 5B is a front view showing the damper in FIG. 5A.

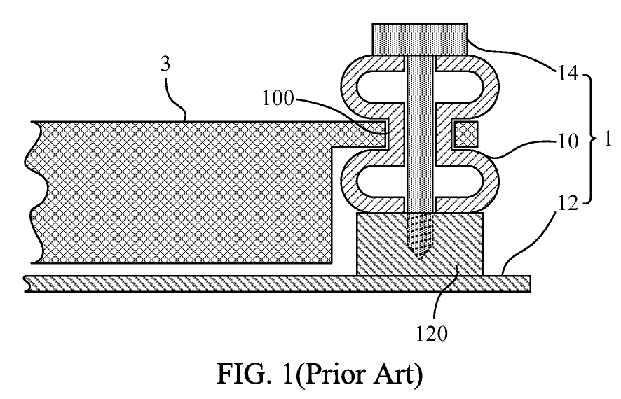

### DETAILED DESCRIPTION OF THE INVENTION

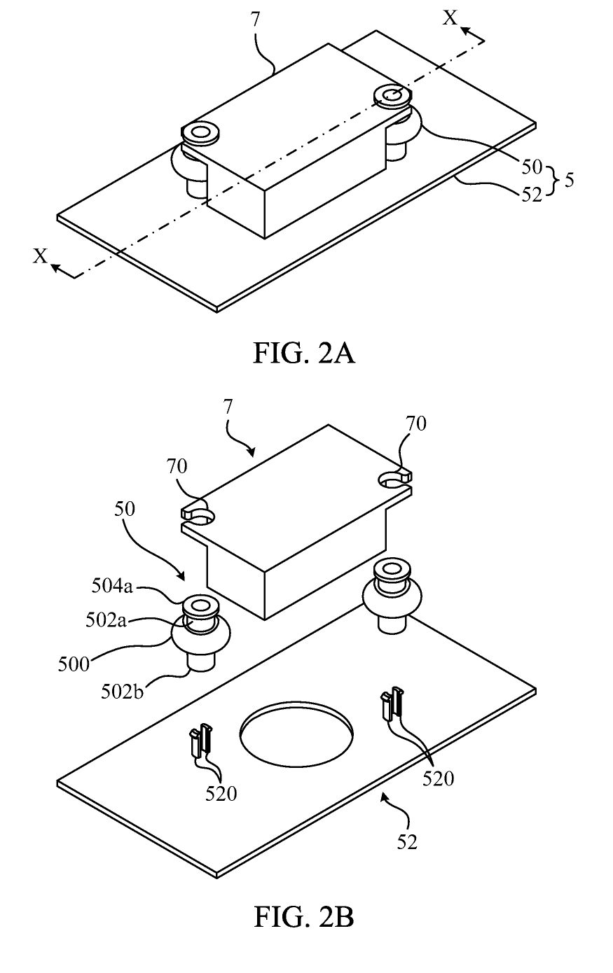

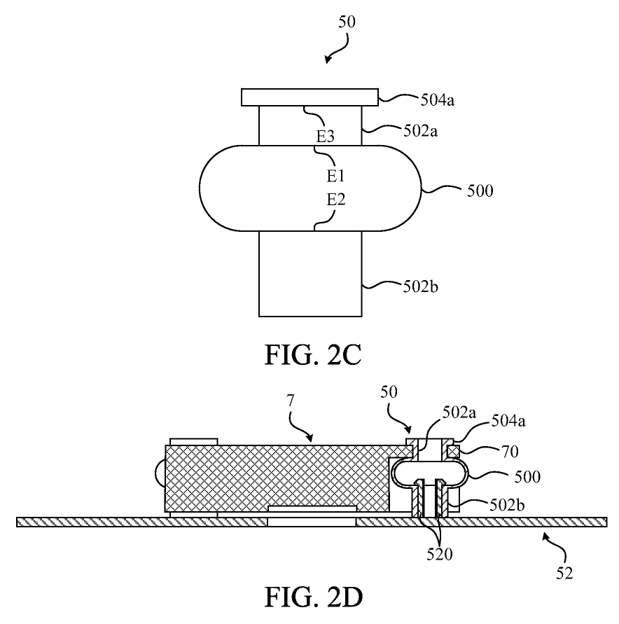

As shown in FIG. 2A to FIG. 2D, FIG. 2A is a schematic diagram showing the appearance of the fixing device 5 fixing the object 7 according to an embodiment of the invention. FIG. 2B is an exploded diagram showing the fixing device and the object shown in FIG. 2A. FIG. 2C is a front view showing the damper 50 in FIG. 2B. FIG. 2D is a sectional diagram taken along section line X-X in FIG. 2A. In the embodiment, the object 7 is a speaker, but the invention should not be limited thereto. The fixing device 5 includes a damper 50 and a base 52. The damper 50 is made of elastic material such as rubber.

As shown in FIG. 2B, the object 7 includes two fastening portions 70, and the base 52 also includes two fastening portions 520. Each of the fastening portions 520 includes a pair of hooks. The damper 50 includes a damping portion 500, pillar-shaped portions 502a and 502b and a block portion 504a. As shown in FIG. 2C, the damping portion 500 has a first end E1 and a second end E2, and the pillar-shaped portion 502a has a third end E3 away from the first end E1. The pillar-shaped portion 502a protrudes from the first end E1, the pillar-shaped portion 502b protrudes from the second end E2, and the block portion 504a protrudes from the third end E3.

When the components are assembled, first, a user may fasten the fastening portion 70 of the object 7 to the pillar-shaped portion 502a of the damper 50. After fastened, the fastening portion 70 of the object 7 is located between the damping portion 500 of the damper 50 and the block portion 504a, as shown in FIG. 2D. Then, the user fastens the fastening portion 520 of the base 52 to the pillar-shaped portion 502b of the damper 50. In the embodiment, the pillar-shaped portion 502b is hollow. This allows the fastening portion 520 of the base 52 to enter into the pillar-shaped portion 502b to be fastened inside the pillar-shaped portion 502b, as shown in FIG. 2D. Thus, in the invention, the damper 50 is used to fix the object 7 to the base 52 without screws.

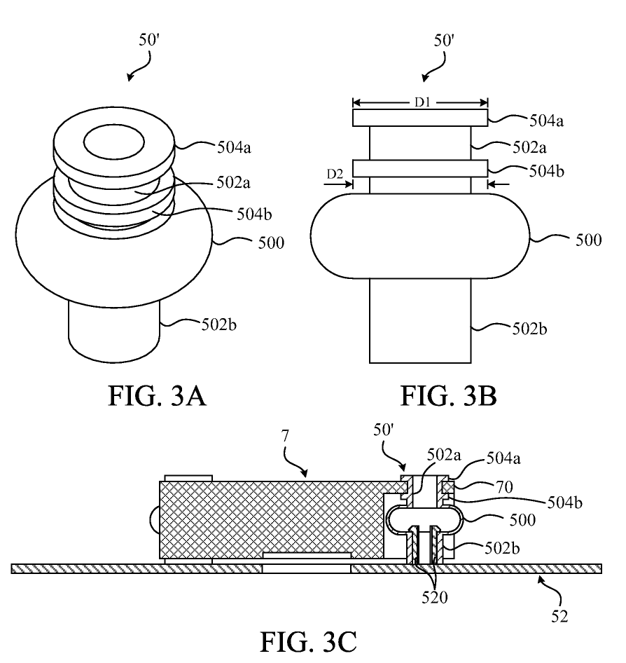

As shown in FIG. 3A to FIG. 3C, FIG. 3A is a schematic diagram showing the appearance of the damper 50′ according to another embodiment of the invention. FIG. 3B is a front view showing the damper 50′ in FIG. 3A. FIG. 3C is a sectional diagram showing that the damper 50′ fixes the object 7 to the base 52 in FIG. 3A. The difference between the damper 50′ and the damper 50 is that the damper 50′ additionally includes a block portion 504b. The block portion 504b protrudes from the pillar-shaped portion 502a and located between the block portion 504a and the damping portion 500. In the embodiment, an external diameter D1 of the block portion 504a is approximately the same as an external diameter D2 in the block portion 504b.

When the components are assembled, first, the user may fasten the fastening portion 70 of the object 7 between the block portion 504a and the block portion 504b, as shown in FIG. 3C. Then, the user makes the fastening portion 520 of the base 52 to enter into the pillar-shaped portion 502b to make the fastening portion 520 fastened inside the pillar-shaped portion 502b, as shown in FIG. 3C. In the embodiment, since the fastening portion 70 of the object 7 is fastened between the block portion 504a and the block portion 504b, when the object 7 works, it does not contact the damping portion 500 of the damper 50′. Thus, the collision and abrasion may be avoided.

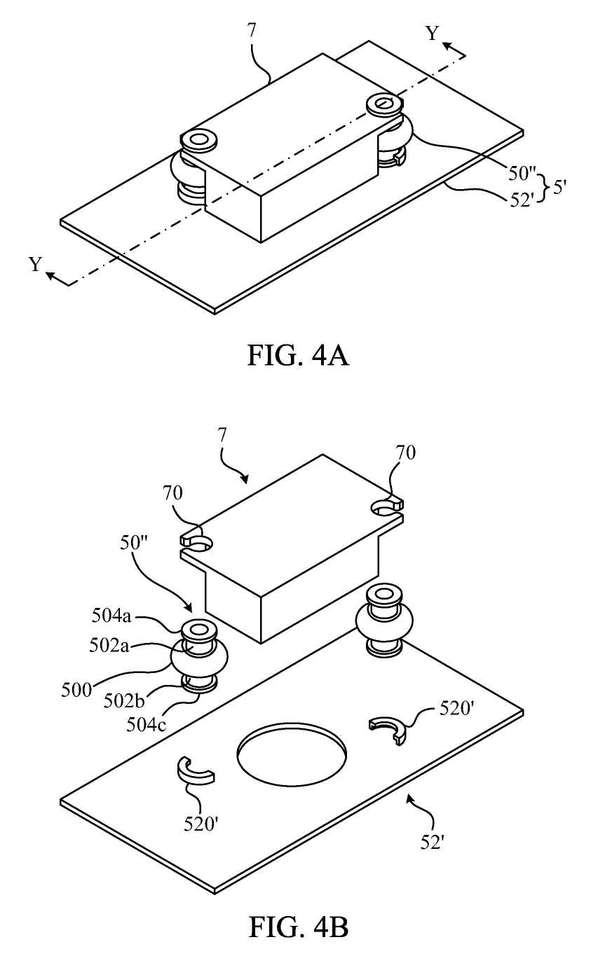

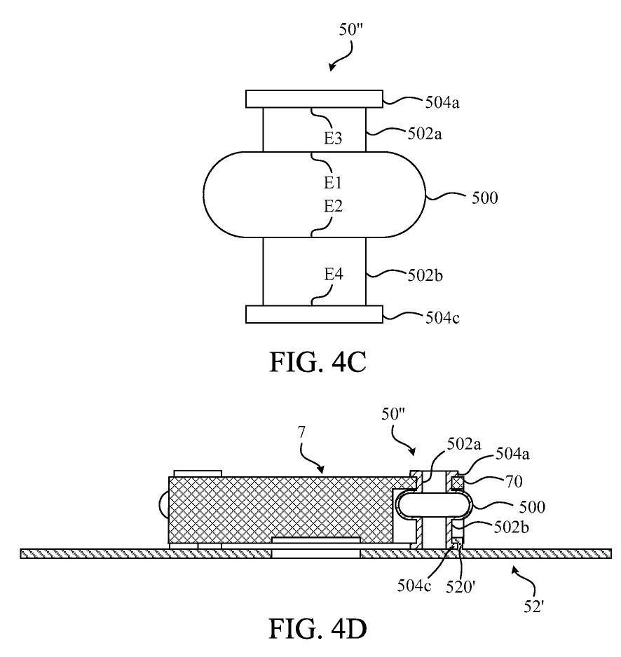

As shown in FIG. 4A to FIG. 4D, FIG. 4A is a schematic diagram showing the appearance of the fixing device 5′ fixing the object 7 according to still another embodiment of the invention. FIG. 4B is an exploded diagram showing the fixing device and the object shown in FIG. 4A.

FIG. 4C is a front view showing the damper 50″ in FIG. 4B. FIG. 4D is a sectional diagram taken along section line Y-Y in FIG. 4A.

As shown in FIG. 4B, the object 7 includes two fastening portions 70, and the base 52′ also includes two fastening portions 520′. The damper 50″ includes a damping portion 500, pillar-shaped portions 502a and 502b and block portions 504a and 504c. As shown in FIG. 4C, the pillar-shaped portion 502a protrudes from the first end E1 of the damping portion 500, the pillar-shaped portion 502b protrudes from the second end E2 of the damping portion 500, the block portion 504a protrudes from the third end E3 of the pillar-shaped portion 502a, and the block portion 504c protrudes from the fourth end E4 of the pillar-shaped portion 502b.

When the components are assembled, the user may first fasten the fastening portion 70 of the object 7 to the pillar-shaped portion 502a of the damper 50″. After fastened, the fastening portion 70 of the object 7 is located between the damping portion 500 of the damper 50″ and the block portion 504a, as shown in FIG. 4D. Then, the user fastens the fastening portion 520′ on the base 52′ to the block portion 504c of the damper 50, as shown in FIG. 4D. Thus, the damper 50″ in the invention can fasten the object 7 to the base 52′ without screws.

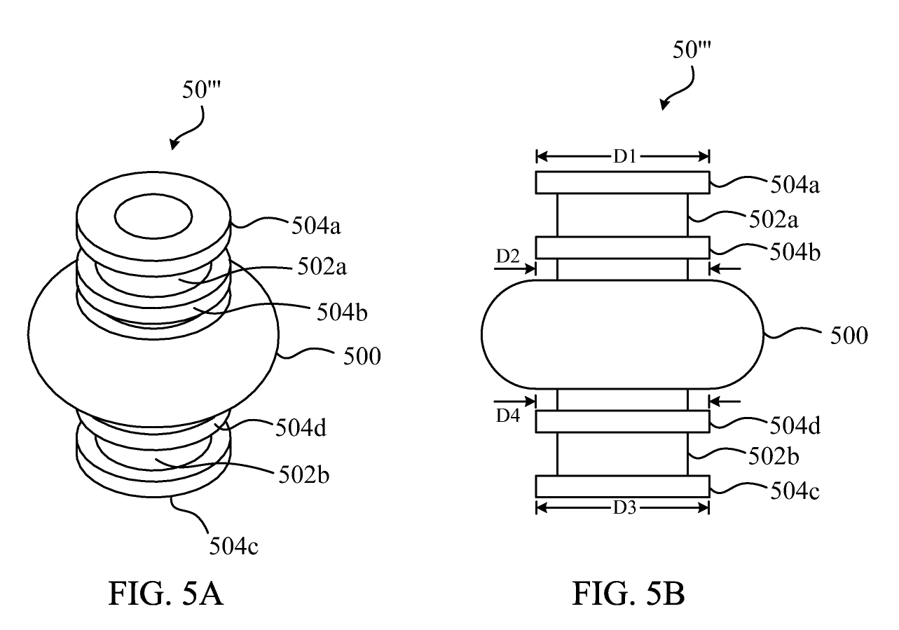

As shown in FIG. 5A and FIG. 5B, FIG. 5A is a schematic diagram showing the appearance of the damper 50′″ according to a fourth embodiment of the invention, and FIG. 5B is a front view showing the damper 50′″ in FIG. 5A. The damper 50′″ includes a damping portion 500, pillar-shaped portions 502a and 502b and block portions 504a, 504b, 504c and 504d. An external diameter D1 of the block portion 504a is approximately the same as an external diameter D2 of the block portion 504b. An external diameter D3 of the block portion 504c is approximately the same as an external diameter D4 of the block portion 504d. In the embodiment, the damper 50′″ is designed to be up-down symmetrical. When a fastening end where the damper 50′″ is fastened to the object wears away, the user may overturn the damper 50′″ to use the damper 50′″. Thus, the lifespan of the damper 50′″ is prolonged. The function of the damper 50′″ is the same as that of the embodiments above, and it is not illustrated for concise purpose.

Compared with the conventional technology, according to the damper in the invention, the user can fasten the object (such as a speaker) to the base using the damper without screws because of the special design in structure. The resonance of the speaker and the casing may be avoided without screws. This saves the material cost of screws, and the components are easily assembled without tools. In addition, the block portion in the invention may be used to separate the fastening portion of the speaker from the block portion of the damper. This may avoid the collision and abrasion.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A damper for assembling a speaker to a base, comprising:
a damping portion having a first end and a second end;
a first pillar-shaped portion protruding from the first end, wherein the first pillar-shaped portion has a third end away from the first end;
a first block portion protruding from the third end, wherein the speaker is fastened to the first pillar-shaped portion and between the damping portion and the first block portion; and
a second pillar-shaped portion protruding from the second end, wherein the second pillar-shaped portion is fastened to the base.

2. The damper according to claim 1, additionally comprising a second block portion protruding from the first pillar-shaped portion and located between the first block portion and the damping portion.

3. The damper according to claim 2, wherein an external diameter of the first block portion is approximately the same as an external diameter of the second block portion.

4. The damper according to claim 1, additionally comprising a third block portion, wherein the second pillar-shaped portion has a fourth end away from the second end, and the third block portion protrudes from the fourth end.

5. The damper according to claim 4, additionally comprising a fourth block portion protruding from the second pillar-shaped portion and located between the third block portion and the damping portion.

6. The damper according to claim 5, wherein an external diameter of the third block portion is approximately the same as an external diameter of the fourth block portion.

7. A fixing device for fixing an object including a first fastening portion, the fixing device comprising:
a damper including:
a damping portion having a first end and a second end;
a first pillar-shaped portion protruding from the first end, wherein the first pillar-shaped portion has a third end away from the first end;
a first block portion protruding from the third end, wherein the first fastening portion of the object is fastened to the first pillar-shaped portion and located between the damping portion and the first block portion; and
a second pillar-shaped portion protruding from the second end; and
a base including a second fastening portion fastened to the second pillar-shaped portion.

8. The fixing device according to claim 7, wherein the damper additionally comprises a second block portion protruding from the first pillar-shaped portion and located between the first block portion and the damping portion, and the first fastening portion of the object is fastened between the first block portion and the second block portion.

9. The fixing device according to claim 8, wherein an external diameter of the first block portion is approximately the same as an external diameter of the second block portion.

10. The fixing device according to claim 7, wherein the second pillar-shaped portion is hollow, and the second fastening portion of the base is fastened inside the second pillar-shaped portion.

11. The fixing device according to claim 7, wherein the damper additionally comprises a third block portion, the second pillar-shaped portion has a fourth end away from the second end, and the third block portion protrudes from the fourth end.

12. The fixing device according to claim 11, wherein the third block portion is fastened to the second fastening portion of the base.

13. The fixing device according to claim 11, wherein the damper additionally comprises a fourth block portion protruding from the second pillar-shaped portion and located between the third block portion and the damping portion.

14. The fixing device according to claim 13, wherein an external diameter of the third block portion is approximately the same as an external diameter of the fourth block portion.

15. The fixing device according to claim 7, wherein the object is a speaker.
